(19) United States
(12) Patent Application Publication
(10) Pub. No.: US 2026/0222870 A1
(43) Pub. Date: Jul. 30, 2026

(54) INFORMATION PROCESSING METHOD AND APPARATUS, COMMUNICATION DEVICE, AND STORAGE MEDIUM

(71) Applicant: Beijing Xiaomi Mobile Software Co., Ltd., Beijing (CN)

(72) Inventor: Min LIU, Beijing (CN)

(73) Assignee: Beijing Xiaomi Mobile Software Co., Ltd., Beijing (CN)

(21) Appl. No.: 19/145,458

(22) PCT Filed: Jan. 3, 2023
(86) PCT No.: PCT/CN2023/070244

§ 371 Date: Jul. 2, 2025

(51) Int. Cl. H04W 24/10; H04B 7/06; H04W 24/08

(52) U.S. Cl. CPC H04W 24/10; H04B 7/0626; H04W 24/08

(57) ABSTRACT

An information processing method executed by a user equipment (UE) includes: sending first information related to a plurality of pieces of first channel state information (CSI), wherein the plurality of pieces of first CSI are obtained by encoding second CSI of one channel measurement using a plurality of different overhead values.

### CROSS REFERENCE TO RELATED APPLICATION

This application is a National Stage of International Application No. PCT/CN2023/070244, filed on Jan. 3, 2023, which is incorporated by reference herein in its entirety for all purposes.

### TECHNICAL FIELD

The present disclosure relates, but is not limited to, the field of wireless communication technology, and particularly relates to a method and an apparatus for processing information, a communication device, and a computer storage medium.

### BACKGROUND

In wireless communication systems, to ensure the quality of wireless communication, it is necessary to estimate the channel characteristics between the terminal and the base station for wireless communication and conduct data transmission based on such characteristics. To accurately estimate these channel characteristics, the terminal can feed back the channel state information (CSI) reflecting the channel characteristics to the base station. Based on this channel state information (CSI), the appropriate communication parameters can be selected by the base station for communication to ensure communication quality.

### SUMMARY

A method and an apparatus for processing information, a communication device, and a computer storage medium are provided in the embodiments of the present disclosure.

According to the first aspect in the embodiments of the present disclosure, a method for processing information is provided, being performed by a user equipment UE and including: sending first information related to a plurality of first channel state information CSIs, where the plurality of first CSIs are obtained by encoding, with a plurality of different overhead values, a second CSI of a single channel measurement.

According to the second aspect in the embodiments of the present disclosure, a method for processing information is provided, being performed by a network device, and including: receiving first information related to a plurality of first channel state information CSIs, where the plurality of first CSIs are obtained by encoding, with a plurality of different overhead values, a second CSI of a single channel measurement.

According to the third aspect in the embodiments of the present disclosure, an apparatus for processing information is provided, including: a sending module, configured to send first information related to a plurality of first channel state information CSIs, where the plurality of first CSIs are obtained by encoding, with a plurality of different overhead values, a second CSI of a single channel measurement.

According to the fourth aspect in the embodiments of the present disclosure, an apparatus for processing information is provided, including: a receiving module, configured to receive first information related to a plurality of first channel state information CSIs, where the plurality of first CSIs are obtained by encoding, with a plurality of different overhead values, a second CSI of a single channel measurement.

According to the fifth aspect in the embodiments of the present disclosure, a communication device is provided, including a processor, a transceiver, a memory, and an executable program stored on the memory and capable of being run by the processor, where the processor, when running the executable program, performs the method for processing information according to any technical solution of the first aspect and/or the second aspect.

According to the sixth aspect in the embodiments of the present disclosure, a non-transitory computer-readable storage medium storing an executable program is provided. Where the executable program, when executed by a processor, can implement the method for processing information according to any technical solution of the first aspect and/or the second aspect.

Based on the technical solution according to some embodiments of the present disclosure, for a single channel measurement result obtained by a single channel measurement, an original CSI (i.e., the second CSI) corresponding thereto can be compressed according to multiple different overhead values, thereby deriving multiple first CSIs. The first information related to the multiple first CSIs can be sent. Due to the different overhead values, the feedback performance, such as the accuracy of the measurement results carried by each first CSI, may be different, thereby meeting the different application requirements of the receiving end.

It should be understood that the above general description and the detailed description below are merely exemplary and explanatory, and do not limit the embodiments of the present disclosure.

### BRIEF DESCRIPTION OF THE DRAWINGS

The accompanying drawings, which are incorporated in and constitute a part of this specification, illustrate embodiments of the present disclosure and, together with the specification, serve to explain the principles of the present disclosure.

FIG. 1 is a structural schematic diagram of a wireless communication system according to an exemplary embodiment.

FIG. 2A is a flowchart of a method for processing information according to an exemplary embodiment.

FIG. 2B is a flowchart of a method for processing information according to an exemplary embodiment.

FIG. 2C is a flowchart of a method for processing information according to an exemplary embodiment.

FIG. 2D is a flowchart of a method for processing information according to an exemplary embodiment.

FIG. 2E is a flowchart of a method for processing information according to an exemplary embodiment.

FIG. 3A is a flowchart of a method for processing information according to an exemplary embodiment.

FIG. 3B is a flowchart of a method for processing information according to an exemplary embodiment.

FIG. 3C is a flowchart of a method for processing information according to an exemplary embodiment.

FIG. 4 is a structural schematic diagram of an apparatus for processing information according to an exemplary embodiment.

FIG. 5 is a structural schematic diagram of an apparatus for processing information according to an exemplary embodiment.

FIG. 6 is a structural schematic diagram of a UE according to an exemplary embodiment.

FIG. 7 is a structural schematic diagram of a network device according to an exemplary embodiment.

### DETAILED DESCRIPTION

The exemplary embodiments will be described in detail here, and their examples are illustrated in the attached drawings. When the description refers to the drawings, unless otherwise indicated, the same numbers in different drawings represent the same or similar elements. The embodiments described in the following exemplary embodiments do not represent all the embodiments consistent with the present disclosure. On the contrary, they are only examples of devices and methods consistent with some aspects of the present disclosure.

The terms used in the present disclosure are merely to describe specific embodiments and are not intended to limit the present disclosure. The singular forms “a”, “an”, and “the” used in the present disclosure are intended to include the plural forms as well, unless the context clearly indicates otherwise. It should also be understood that the terms “and/or” used herein refer to and include any or all possible combinations of one or more of the associated listed items.

It should be understood that although the terms “first”, “second”, “third”, etc. may be used in the present disclosure to describe various information, such information should not be limited to these terms. These terms are only used to distinguish the same type of information from each other. For example, in the context of the present disclosure, the first information may also be referred to as the second information, and similarly, the second information may also be referred to as the first information. Depending on the context, for example, the word “if” used herein can be interpreted as “when”, “at the time of”, or “in response to determining that . . . ”.

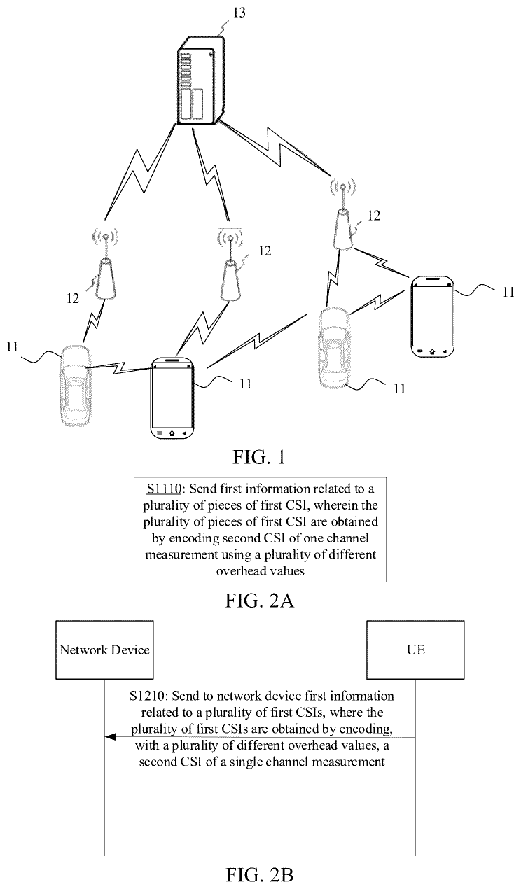

Referring to FIG. 1, FIG. 1 shows a structural schematic diagram of a wireless communication system provided by an embodiment of the present disclosure. As shown in FIG. 1, the wireless communication system is a communication system based on cellular mobile communication technology. The wireless communication system may include: a plurality of UEs 11 and a plurality of network devices. The network devices may include the access devices 12 shown in FIG. 1, and/or core network devices not shown in FIG. 1.

The UE 11 may refer to a device providing voice and/or data connectivity to users. UE 11 can communicate with one or more core networks via a radio access network (RAN). UE 11 may be an Internet of Things UE, such as sensor devices, mobile phones (also referred to as cellular phones), and computers with Internet of Things UE. For example, UE 11 may be a fixed, portable, pocket-sized, handheld, computer-integrated or vehicle-mounted device, for example, station (STA), subscriber unit, subscriber station, mobile station, mobile, remote station, access point, remote terminal, access terminal, user terminal, user agent, user device, or user equipment (UE). Alternatively, UE 11 may also be a device of an unmanned aerial vehicle. Alternatively, UE 11 may also be a vehicle-mounted device, such as a vehicle-mounted computer with wireless communication functions, or a wireless communication device connected to a vehicle-mounted computer. Alternatively, UE 11 may also be a roadside device, such as a street lamp, traffic signal, or other roadside devices with wireless communication functions.

Access device 12 may be a network-side device in the wireless communication system. The wireless communication system may be the fourth-generation mobile communication (4G) system, also known as a long-term evolution (LTE) system; or, the wireless communication system may also be a 5G system, also known as a New Radio (NR) system or 5G NR system. Alternatively, the wireless communication system may also be the next generation system after the 5G system. In the 5G system, the access network may be called a next-generation radio access network (NG-RAN). Alternatively, the wireless communication system may also be an MTC system.

Access device 12 may be a core network device adopted in the wireless communication system. The core network device may be various physical network unit entities or logical network units, such as access and mobility management function (AMF), and Location Management Function (LMF).

Access device 12 may be an evolved NodeB (eNB) adopted in the 4G system. Alternatively, access device 12 may also be an access device with a centralized or distributed architecture adopted in the 5G system (gNB). When the architecture of the access device 12 is in a centralized distributed architecture, the access device 12 typically includes a central unit (CU) and at least two distributed units (DU). The central unit is provided with a packet data convergence protocol (PDCP) layer, a radio link control (RLC) layer, and a media access control (MAC) layer. The distributed unit is provided with a protocol stack of the Physical (PHY) layer. The specific implementation of the access device 12 is not limited by this disclosure.

A wireless connection may be established between the access device 12 and the UE 11 through a wireless air interface. In different implementations, the wireless air interface may be based on the 4G standard; or, the wireless air interface may be based on the 5G standard, such as the new radio interface; or, the wireless air interface may also be based on the wireless air interface in the next generation of mobile communication network technology standard based on 5G.

To better understand the embodiments of the present disclosure, exemplary descriptions of the relevant scenarios of the first CSI are provided.

Under the condition that the input dimension is fixed, in other words, under the condition that the channel state information to be compressed is fixed, for example, the number of input information is equal to the product of the number of base station antenna ports and the number of subbands, different numbers of bits affect the final CSI compression performance.

Through simulation results, it is found that as the number of output bits increases, the compression performance of the CSI compressed based on the AI model is better. The compression performance may be reflected in one or more of the following aspects: compression amount, the degree of difference between the CSI restored after compression and the original CSI, and the like.

Similarly, in the CSI feedback based on codebook, such as the enhanced type (eType) II codebook, under the condition that the base station configures different feedback parameters, the performance of eType II improves as the feedback overhead increases. The feedback parameters may include: compression parameters and/or quantization parameters.

For the CSI feedback based on codebook, the codebook includes, but is not limited to, the enhanced type (eTypeII) codebook, where the same codebook algorithm is adopted by all UEs. Therefore, when the configured feedback parameters are the same, the channel accuracy of the feedback from different UEs is the same.

However, for the AI-based CSI feedback, in the case of separate training, the implementation of the encoder depends on the implementation of each UE. Even if the feedback overhead is the same, some UEs may have better performance while others may have worse performance. To ensure performance fairness, a higher CSI feedback overhead may be required for UEs with a less capable encoder, thereby improving the restored channel accuracy.

The parameters involved in one or more embodiments of the present disclosure are described in the following.

The second CSI is information about the measurement results of the measurement performed by the UE on channel state information-reference signal (CSI-RS). A measurement result may include one or more measurement values.

The second CSI can also be referred to as the original CSI.

The first CSI is a CSI obtained by encoding the second CSI.

Channel measurement may include: measuring the CSI-RS sent on the wireless channel. The CSI report includes the report of the first CSI.

Overhead value can be used to indicate the data volume. The data volume can be represented by the number of bits.

The first information can be used to determine multiple first CSIs with different overhead values. For example, the first information may include multiple first CSIs.

The second information can be any information used to determine the overhead value.

The relevant terms in one or more subsequent embodiments are explained above, but it should be noted that the specific implementation is not limited to the above examples.

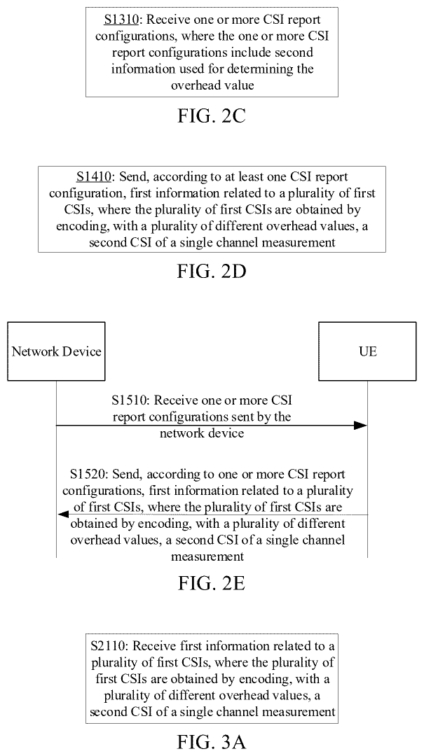

As shown in FIG. 2A, according to the embodiments of the present disclosure, a method for processing information is provided, being performed by a user equipment UE and including the following.

In S1110, first information related to a plurality of first CSIs (channel state information) is sent, where the plurality of first CSIs are obtained by encoding, with a plurality of different overhead values, a second CSI of a single channel measurement.

The UE may be any terminal device shown in FIG. 1. The UE may be a mobile terminal and/or a fixed terminal. The terminal may be, but is not limited to, a mobile phone, a wearable device, a vehicle-mounted terminal, a roadside unit (RSU), a smart home terminal, a smart office device, an industrial sensor device, and/or a medical device, and the like. In some embodiments, the terminal may be a Redcap terminal or a new radio (NR) terminal of a predetermined version.

A single channel measurement may generate one or more measurement values. For example, in a single channel measurement, multiple measurement values may be generated, and the multiple measurement values form a measurement result of the single channel measurement. The second CSI indicates the measurement result of the single channel measurement. The second CSI can also be referred to as the original CSI.

The plurality of first CSIs are obtained by encoding, with a plurality of different overhead values, the second CSI. The overhead values of the multiple first CSIs are different.

The encoding here may include compression, or compression and quantization. Based on different overhead values, a single second CSI is encoded to obtain multiple first CSIs with different overhead values.

For example, if the encoding here includes compression, multiple first CSIs with different overhead values can be obtained by compressing a single second CSI with multiple sets of compression parameters corresponding to different overhead values, respectively.

For another example, if the encoding here includes compression and quantization, multiple first CSIs with different overhead values can be obtained by performing compression and quantization on a single second CSI with multiple sets of compression parameters and/or quantization parameters corresponding to different overhead values, respectively.

In addition, in some embodiments, quantization can be a sub-step of the compression step or an independent step separate from the compression step. The compression process here is the step of compressing the second CSI.

The first information here may include the multiple first CSIs themselves or other information indicating the multiple first CSIs.

Exemplarily, the first information related to different first CSIs can be sent to the receiving end in the same CSI report, or the first information related to multiple first CSIs can be sent to the receiving end in different CSI reports.

In some embodiments of the present disclosure, each of the multiple first CSIs includes all the measurement values of a single channel measurement, but the first CSIs are generated by using different compression parameters and/or quantization parameters, so that the multiple first CSIs correspond to different overhead values. In other words, the multiple first CSIs are different representations of the same measurement result, and the different representations lead to the differences in the overhead values of the first CSIs.

The second CSI may include, but is not limited to, at least one of the following: reference signal received power (RSRP) of the CSI-RS; reference signal received quality (RSRQ); signal to interference plus noise ratio (SINR); channel quality indicator (CQI); precoding matrix indicator (PMI); full channel matrix; channel eigenvector; and the like.

The specific content of the second CSI provided here is just an example, and the specific implementation is not limited to the present example.

Exemplarily, the data form of the first information may include: arrays, vectors, and/or matrices. For example, the CSI may be used for the training, fine-tuning, or supervision of AI models. The fine-tuning can also be referred to as tuning. Thus, by sending the CSIs with different overhead values based on a single channel measurement, the CSI with the corresponding overhead value can be used by the receiving end as needed conveniently, the unfairness in the training, tuning, and/or supervision process of the AI model can be reduced; and the training effect of the AI model can be ensured.

Exemplarily, if the AI model is used for the encoding of channel state information, the encoding here may solely include compression, or the encoding includes compression and quantization in sequence.

Exemplarily, the second CSI may at least include: the original channel state information (CSI) obtained by the UE performing measurement on the CSI-RS. For example, based on the original data obtained by the measurement of the UE for the Channel State Information-Reference Signal (CSI-RS), after being processed by the AI model with different overhead values, the first CSIs corresponding to multiple different overhead values may be obtained.

Exemplarily, the training of the AI model can be training-supervised through sample data and labels of the sample data. For example, the training of the AI model may also be unsupervised training without labels.

The optimization of the AI model can also be referred to as the tuning or fine-tuning of the AI model. In other words, initial training has been performed on the AI model. Considering the special requirements of different application scenarios or different time periods, the AI model already in use or about to be put into use is further trained with a small amount of data, that is, the aforementioned optimization of the AI model.

The supervision of AI models may include: supervision during the training process of AI models and/or supervision during the application process thereof.

Exemplarily, the receiving end may be a network device. In some embodiments, the UE can send, with different overhead values, multiple first CSIs of a single channel measurement based on the performance of the UE and/or protocol agreements and the like. In summary, the result of a single channel measurement is sent, with different overhead values, through multiple first CSIs respectively, so that the receiving end will receive multiple first CSIs with different overheads, and all the first CSIs are related to the result of a single channel measurement. The difference is that although the multiple first CSIs are all related to the result of a single channel measurement, due to different overhead values, the multiple first CSIs have different precisions and the like, thereby meeting different application requirements. For example, the multiple first CSIs may carry the same parameter values, but the parameter values can be parameter values quantized based on the same or different codebooks, so the differences between the original values and the restored values after being restored by the receiving end are different, thereby achieving different reporting precisions.

As shown in FIG. 2B, according to the embodiments of the present disclosure, a method for processing information is provided, being performed by a UE, and including the following.

In S1210, first information related to a plurality of first CSIs is sent to the network device, where the plurality of first CSIs are obtained by encoding, with a plurality of different overhead values, a second CSI of a single channel measurement.

The network device includes, but is not limited to, access devices and/or core network devices. For example, the access device may be an evolved base station and/or a next-generation base station, and the like; and the core network device can be various physical network unit entities or logical network units, such as the access and mobility management function (AMF), the location management function (LMF), and the like.

After completing a single channel measurement, the UE will send the first information related to multiple first CSIs, with different overhead values, to the network device, thereby facilitating the network device to adopt the first CSI with the corresponding overhead value according to the requirements of the network device.

As shown in FIG. 2C, according to the embodiments of the present disclosure, a method for processing information is provided, being performed by a UE, and including the following.

In S1310, one or more CSI report configurations are received, where the one or more CSI report configurations include second information used for determining the overhead value.

The CSI report configurations may come from the network device or other devices. The other devices may include relay devices, gateway devices, network management devices, or the like.

Exemplarily, S1310 may include: receiving one or more CSI report configurations sent by the network device.

The second information in the CSI report configuration may be any information used to determine the overhead value for deriving and sending the multiple first CSIs.

In summary, the UE receives the CSI report configuration. After receiving the CSI report configuration, the CSI can be sent according to the CSI report configuration when the CSI is to be sent. If no CSI is to be sent, the CSI report configuration may not be used.

Exemplarily, the embodiment shown in FIG. 2C can be implemented independently or in combination with any of the aforementioned embodiments, such as in combination with the embodiments shown in FIG. 2A and FIG. 2B. The CSI report configuration can be used by the UE to determine the report resources for sending CSI and the like.

As shown in FIG. 2D, a method for processing information is provided in the embodiments of the present disclosure, being performed by a UE and including the following.

In S1410, according to at least one CSI report configuration, first information related to a plurality of first CSIs is sent, where the plurality of first CSIs are obtained by encoding, with a plurality of different overhead values, a second CSI of a single channel measurement.

In some embodiments, the UE may obtain the CSI report configuration in advance. The CSI report configuration may include configuration information related to CSI transmission. The configuration information may be RRC configuration information and/or MAC CE configuration information.

Exemplarily, the CSI report configuration may indicate at least one of the following: configuration identification (ID); report threshold, for example, when the measured value reaches the report threshold, CSI is determined to be sent; resource information, indicating the report resources for sending the CSI report, where the report resources may be time-domain resources and/or frequency-domain resources; and the reporting amount of CSI report carrying the CIS, where CSI reports with different reporting amounts carry measurement results in different forms and/or different fields and/or different parameter values. For example, some CSI reports carry RSRP, while others carry SINR and the like; some CSI reports carry arrays, while others carry vectors or matrices or the like.

In an embodiment, the CSI report configuration can be used by the UE to determine whether to report one first CSI or multiple first CSIs for a single channel measurement. If the first information related to multiple first CSIs is reported, the UE is to send the first information of multiple first CSIs with different overhead values for a single channel measurement.

In other embodiments, the CSI report configuration may further be used by the UE to determine the overhead values of one or more first CSIs for a single CSI report.

In another embodiment, the CSI report configuration can be used for determination of the UE, for a single channel measurement, to report multiple first CSIs after compression and/or quantization and the original second CSI, or to report only the original second CSI, or to report only the encoded first CSI. If multiple first CSIs and the original second CSI are reported, the UE is to send multiple first CSIs and one second CSI for a single channel measurement, and the multiple first CSIs sent have different overhead values. Different contents carried by the CSI report configuration cause different functions of the CSI report configuration in the process of sending CSI reports.

Exemplarily, in the initial stage of the UE sending CSI, the second CSI and multiple first CSIs with different overhead values obtained by encoding based on different overhead values can be sent respectively according to the CSI report configuration. After the receiving end receives the first information related to the multiple first CSIs with different overhead values, the CSI will be restored, thereby obtaining the restored CSI. The restored CSI is compared with the second CSI directly sent by the UE in terms of feedback performance, so that the overhead value of the first CSI corresponding to the best feedback performance can be determined. Subsequently, an updated CSI report configuration can be used to indicate that the UE should use the overhead value of the first CSI corresponding to the best feedback performance determined in the initial stage, as the target overhead value for subsequent CSI feedback. The feedback performance can be calculated and evaluated by combining the overhead value and the accuracy, and the evaluation value is negatively correlated with the overhead value and positively correlated with the accuracy. The subsequent stage is later than the initial stage.

This is merely exemplary, and the specific implementation is not limited to these examples.

In the embodiments of the present disclosure, the UE sends multiple CSIs with different overhead values for a single channel measurement according to the CSI report configuration.

Exemplarily, the embodiment shown in FIG. 2D can be implemented independently or in combination with any of the previous embodiments, for example, in combination with the embodiments shown in FIG. 2A to FIG. 2C.

As shown in FIG. 2E, a method for processing information is provided in the embodiments of the present disclosure, being performed by a UE and including the following.

In S1510, one or more CSI report configurations sent by the network device are received.

In S1520, according to one or more CSI report configurations, first information related to a plurality of first CSIs is sent, where the plurality of first CSIs are obtained by encoding, with a plurality of different overhead values, a second CSI of a single channel measurement.

Exemplarily, the embodiment shown in FIG. 2E can be implemented in combination with any of the previous embodiments, for example, in combination with the embodiments shown in FIGS. 2A to 2D.

In some embodiments, one CSI report configuration corresponds to multiple overhead values.

Exemplarily, a CSI report configuration can indicate multiple overhead values through configuration information, or the ID of a CSI report configuration can be pre-mapped to multiple overhead values.

For example, in response to the UE receiving one CSI report configuration, the CSI report configuration corresponds to multiple overhead values.

In some embodiments, one CSI report configuration corresponds to one CSI resource configuration.

In some embodiments of the present disclosure, one CSI report configuration corresponds to one CSI resource configuration. The CSI resource configuration can be used at least to determine the CSI-RS to be measured. For example, the CSI resource configuration may include at least one of the following:
a first ID, identifying the CSI resource used for receiving or measuring CSI-RS; and a second ID, identifying the CSI report configuration corresponding to the CSI resource configuration.

A CSI report configuration corresponding to multiple overhead values may correspond to one CSI resource configuration, so that the resources indicated by the CSI resource configuration can be used for sending CSIs with multiple different overhead values.

If a CSI report configuration corresponds to one overhead value, it can also be that one CSI report configuration corresponds to one CSI resource configuration.

Optionally, in the case of some embodiments, the type of the CSI report configuration may be periodic, aperiodic or semi-static. In other words, the type of the CSI report configuration for multiple overhead values may be aperiodic or semi-static. A periodic CSI report configuration may be a dynamic CSI report configuration. A periodic CSI report configuration may indicate that the UE sends CSI reports periodically.

For example, if the CSI report configuration is a periodic configuration, CSI reports are sent periodically. For example, when the sending time corresponding to the sending period arrives, the first information of multiple first CSIs for a single channel measurement is sent with different overhead values. The first information is carried in the CSI report. For example, multiple first CSIs for a single channel measurement can be sent to the receiving end in the same period, or sent to the receiving end in different periods respectively.

Exemplarily, the type of the CSI report configuration is aperiodic. It can be understood that the aperiodic CSI report configuration may be a dynamic CSI report configuration, and can be flexibly and timely configured by physical layer signaling.

Exemplarily, the type of the CSI report configuration is semi-static, it can be understood that within the time range of the semi-static configuration, the CSI report configuration is configured according to the semi-static period.

In some embodiments, a CSI report configuration corresponds to an overhead value of a CSI report. In other words, in these embodiments, a CSI report configuration can be used to determine an overhead value. Thus, if first information related to multiple first CSIs is to be sent, multiple CSI report configurations may be required.

Exemplarily, in response to the UE receiving multiple CSI report configurations, each of the multiple CSI report configurations corresponds to an overhead value.

In some embodiments, multiple CSI report configurations correspond to the same CSI resource configuration, where the overhead values of the CSI reports corresponding to different CSI report configurations are different.

If a CSI report configuration corresponds to an overhead value, then multiple CSI report configurations may correspond to the same CSI resource configuration, and the overhead values of the CSIs corresponding to the same CSI resource configuration are different.

Exemplarily, a CSI resource configuration can be used at least for determining the transmission resources for sending first information related to multiple first CSIs with different overhead values.

In an embodiment, the type of the CSI report configuration is non-periodic or semi-static. Understandably, the type of the CSI report configuration, at least corresponding to an overhead value, may be non-periodic or semi-static.

In some embodiments, sending first information related to multiple first CSIs may include at least one of the following: based on a periodic CSI report configuration, multiple CSIs with different overhead values for a single channel measurement are periodically sent. According to a non-periodic CSI report configuration, the first information related to multiple first CSIs of a single channel measurement is sent based on a non-periodic trigger state, where the multiple first CSIs are obtained by encoding, with a plurality of different overhead values, a second CSI of a single channel measurement. According to a semi-static CSI report configuration, the first information related to multiple first CSIs of a single channel measurement is sent based on a semi-static activation state, where the multiple first CSIs are obtained by encoding, with a plurality of different overhead values, a second CSI of a single channel measurement.

For example, the CSI report configuration is a non-periodic configuration. The CSI report configuration may include condition information. The condition information can indicate the trigger condition for entering the trigger state. For instance, if the measurement value of the CSI-RS of the serving cell drops to the reporting threshold satisfying the trigger condition, and/or the measurement value of the CSI-RS of the neighboring cell rises to the reporting threshold satisfying the trigger condition, it can be considered that the CSI report configuration enters the non-periodic trigger state, so one or more CSIs with different overhead values may be sent according to the CSI resource configuration corresponding to the CSI report configuration. If the CSI report configuration does not enter the non-periodic trigger state, then for the result of a channel measurement, multiple CSIs with different overhead values will not be sent. If multiple CSIs with different overhead values are not sent for the result of a channel measurement, then one CSI can be sent for the channel measurement, or no CSI is sent.

In this way, the network devices can send an instruction to indicate whether the UE enters the non-periodic trigger state according to requirement, thereby triggering the UE to send or stop sending multiple CSIs with different overhead values for a channel measurement.

In other embodiments, the CSI report configuration may be a semi-static configuration, and the semi-static configuration has a semi-static period. Whether to send CSI on the corresponding semi-static period can be determined based on the state of the CSI report configuration. For example, if the network signaling indicates that the CSI report configuration corresponding to the semi-static period is set to the active state, then CSI is sent on the semi-static period. If no network signaling indicates that the CSI report configuration corresponding to the semi-static period is set to the active state, or the CSI report configuration corresponding to the semi-static period is set to the deactivate state by network signaling, then CSI is not sent during the corresponding semi-static period. If the semi-static activation state is not entered, then for a single channel measurement result, CSI with multiple overhead values will not be sent. If the CSI with multiple overhead values is not sent for a single channel measurement result, then a single CSI can be sent for a single channel measurement, or no CSI is sent.

In this way, the network devices can send an instruction to indicate whether the UE enters the semi-static activation state according to requirement, thereby triggering the UE to send or stop sending multiple CSIs with different overhead values for a channel measurement.

For example, the CSI includes three report types: non-periodic reports, semi-static reports, and/or periodic reports. The specific type of report can be determined by the CSI report configuration. In other words, the CSI report configuration includes type information. The type information indicates the report type of CSI.

In some embodiments, the second information includes the following: at least one piece of first indication information, where one piece of the first indication information is used to determine, in combination with other information, an overhead value corresponding to the CSI report configuration, where the other information may be any information that can be used to determine at least one overhead value in assistant with the first indication information; one piece of second indication information, used to determine the number of overhead values; and/or, at least one piece of third indication information, used to determine at least one overhead value of the CSI report configuration independently.

In some embodiments, if a CSI report configuration corresponds to multiple overhead values of CSI, then the CSI report configuration may include multiple pieces of first indication information, with each piece of first indication information corresponding to one overhead value.

For example, at least one piece of first indication information may include: one piece of first indication information or multiple pieces of first indication information. If one CSI report configuration corresponds to the overhead of one CSI, then the CSI report configuration includes one piece of first indication information. If one CSI report configuration corresponds to the overhead values of multiple CSIs, then the CSI report configuration includes multiple pieces of first indication information.

For example, multiple pieces of first indication information may correspond to one bit map or one indication field.

One bit in a bit map corresponds to one overhead value. If the value of the bit is a specific value, it indicates that the CSI report configuration corresponds to the overhead value mapped by the present bit; otherwise, the CSI report configuration does not correspond to the overhead value. The specific value is 0 or 1. Accordingly, the number of overhead values corresponding to the CSI report configuration may be equal to the number of bits in the bit map with the specific value.

One indication field corresponds to one overhead value. If the indication field can correspond to one overhead value or explicitly indicate the overhead value, it indicates that the CSI report configuration indicates the corresponding overhead value; otherwise, the CSI of the CSI report configuration does not correspond to the overhead value. If the CSI report configuration corresponds to a certain overhead value, the CSI report configuration contains the indication field. The number of overhead values corresponding to the CSI report configuration may be equal to the number of indication fields. Whether the CSI report configuration corresponds to a certain overhead value does not depend on whether the CSI report configuration contains the indication field, but is to be determined based on the content of the indication field, then the number of overhead values corresponding to one CSI report configuration may be determined by the content of the indication field.

For example, one piece of first indication information corresponds to one overhead value of CSI. For instance, the first indication information indicates a preset parameter. The preset parameter has a corresponding relationship with the overhead value, or one piece of first indication information indicates an overhead value index. For example, the preset parameter may include: one or more of compression rate and/or input dimension and/or output dimension parameters and the like. After receiving the CSI report configuration, one overhead value can be determined based on one piece of first indication information according to the protocol agreement or the pre-configuration of the network.

The second indication information can be used to indicate the number of overhead values corresponding to one CSI report configuration. For example, if the second indication information indicates N, then one CSI report configuration corresponds to N overhead values of a single channel measurement. The value of N may be a positive integer, such as 1 or 2 or the like.

For example, if one CSI report configuration corresponds to one overhead value, then the value of the second indication information may be 1. If one CSI report configuration corresponds to x overhead values, then the second indication information indicates x, where x may be a positive integer greater than or equal to 2.

In some embodiments, the UE may send first information related to multiple first CSIs of a single channel measurement based on multiple CSI report configurations. The overhead values of the multiple first CSIs are different. For example, any one of the multiple CSI report configurations may correspond to the overhead value of one first CSI; or, some of the multiple CSI report configurations correspond to the overhead value of one first CSI, but some CSI report configurations may correspond to the overhead values of multiple first CSIs.

The aforementioned other information assisting in determining the overhead value based on the first indication information may be network configuration and/or predefined rules.

The network configuration may include: any network signaling sent by the network device before or after sending the CSI report. The network signaling may be RRC signaling and/or MAC layer signaling. The network signaling may include: the overhead value corresponding to the first indication information.

Optionally, one or more network signals, sent by the network device before sending the CSI report configuration, carry the overhead value corresponding to the first indication information.

Optionally, the network signaling may include: an indicator of the overhead value and the specific overhead value. The first indication information and the second indication information in the CSI report configuration may indicate the indicator of the overhead value or one or more parameters corresponding to the overhead value. The specific value of each overhead value can be determined by querying the network signaling based on the indicator or parameter. The indicator may include but is not limited to an identifier. The parameter includes but is not limited to a precoding matrix indicator or a rank indicator.

Accordingly, after receiving the first indication information, the UE queries the network configuration based on the first indication information to determine the overhead value corresponding to the first indication information.

Optionally, the predefined rules may include, but are not limited to, at least one of the following: rules agreed upon by the protocol; rules agreed upon through negotiation between the UE and the network device; rules designated by the communication operator; and/or rules designated by the device supplier and the like.

These are merely examples of predefined rules, and the specific implementation is not limited to the examples.

All the described predefined manners include the overhead value corresponding to the first indication information. After receiving the first indication information, the UE can obtain the overhead value corresponding to the first indication information by querying the predefined rules.

In summary, after receiving the first indication information or the second indication information, the UE is to determine the number of overhead values corresponding to the CSI report configuration based on the first indication information or the second indication information, and then determine the specific values of each overhead value according to the predefined rules or network configuration.

In some embodiments, the third indication information indicates the overhead value corresponding to the CSI report configuration.

Alternatively, the third indication information includes preset parameters for calculating at least one overhead value corresponding to the CSI report configuration.

The third indication information may directly indicate the overhead value, in other words, the third indication information explicitly indicate the overhead value; or the third indication information indicate the preset parameters that can be used to calculate the overhead value, in other words, the third indication information implicitly indicate the overhead value.

When the CSI report configuration includes the third indication information, the number of overhead values indicated by the third indication information can be used to determine transmission of the first information related to the corresponding number of first CSIs according to the CSI report configuration and for a single channel measurement.

For example, the third indication information indicates the overhead value of the CSI. In the embodiment, the third indication information explicitly indicates the overhead value of the CSI.

For example, the third indication information includes preset parameters for calculating the overhead value corresponding to a CSI report configuration.

The preset parameters may be any encoding parameters for encoding the second CSI and/or monitoring parameters related to monitoring the CSI-RS.

The encoding parameters may include compression parameters and/or quantization parameters.

The monitoring parameters may include: the number of subbands for monitoring the CSI-RS and/or the number of ports for monitoring the CSI-RS and the like.

In summary, if the third indication information includes preset parameters, the overhead value corresponding to the CSI report configuration is implicitly indicated by the preset parameters. After receiving the third indication information, the UE can calculate the overhead value based on the third indication information independently. The signaling overhead of the CSI report configuration can be saved. In other words, based on the third indication information, the overhead value can be calculated without referring to other information.

In some embodiments, the preset parameters include at least one of the following: an input dimension parameter before CSI compression/encoding; a compression rate/encoding rate of the CSI compression/encoding; an output dimension parameter after the CSI compression/encoding; the number of CSI-RS ports; the number of sub-bands; and/or a quantization parameter.

The UE measures the CSI-RS and obtains the original CSI.

In some embodiments, after obtaining the second CSI through CSI-RS measurement, CSI compression is performed. After completing the CSI compression, quantization after compression is carried out, and the first CSI is obtained after quantization.

In another embodiment, after obtaining the second CSI through CSI-RS measurement, CSI compression is performed to obtain the first CSI.

The aforementioned compression and/or quantization all belong to the encoding of the second CSI.

In some cases, “compression” in the embodiments of the present disclosure is also referred to as “encoding”. Therefore, the output dimension parameter after CSI compression/encoding is the output dimension parameter after CSI compression or the output dimension parameter after CSI encoding.

For example, based on one input dimension parameter after CSI compression/encoding, one output dimension parameter before CSI compression/encoding, and the compression rate/encoding rate of CSI compression/encoding, the overhead value can be calculated.

For another example, based on the number of CSI-RS ports, one output dimension parameter after CSI compression/encoding, one input dimension parameter before CSI compression/encoding, and the compression rate/encoding rate of CSI compression/encoding, the overhead value can be calculated.

For another example, after one or more parameters affecting the overhead value are uniquely determined, the overhead value can also be determined based on the remaining parameters affecting the overhead value.

For example, if the number of CSI-RS ports and/or the number of sub-bands are pre-configured through CSI resource configuration, the CSI report configuration can indicate, through the first indication information, the output dimension parameter after CSI compression/encoding, the input dimension parameter before CSI compression/encoding, and the compression rate, and the overhead value can be calculated.

When performing CSI compression/encoding, CSI compression/encoding parameters will be used.

The CSI compression/encoding parameters may include at least one of the following.

Compression method can be called encoding method or compression/encoding method. Different compression methods can adopt different types of AI models for CSI compression. The AI model may include a fully connected AI model and/or a transformer model.

Compression rate can also be called encoding rate or compression/encoding rate.

The higher the compression rate, the greater the data volume ratio of CSI before and after compression; and vice versa.

If an AI model is used for CSI compression, the input dimension and output dimension of the compression model used for CSI compression are determined. The input dimension of the compression model may be indicated by the CSI compression/encoding input dimension parameter. The output dimension of the compression model can be indicated by the CSI compression/encoding output dimension parameter.

In some embodiments, the input dimension of the compression model can be equal to the output dimension of the compression model, or the input dimension of the compression model can be greater than the output dimension of the compression model.

In some embodiments, the CSI compression/encoding input dimension parameter can also be referred to as the CSI compression input parameter or the CSI encoding input dimension parameter.

In some embodiments, the number of CSI-RS ports is the number of ports for UE receiving CSI-RS.

In some embodiments, the number of sub-bands is the number of sub-bands for UE receiving CSI-RS.

In some embodiments, the product of the number of CSI-RS ports, the number of sub-bands, and the compression ratio can be equal to the output dimension of the compression model.

When performing CSI quantization, quantization parameters will be used.

The quantization parameters can indicate at least one of the following: quantization method; and/or quantization precision.

Different quantization methods correspond to quantization logics or quantization tools. For example, scalar quantization can directly truncate the data beyond the quantization unit according to the quantization unit, so as to achieve the quantization of data elements in the data set. The described is just an example. For instance, if the quantization unit is the Nth digit after the decimal point, then data beyond the Nth digit refers to data values exceeding the quantization unit and truncated during quantization.

The quantization parameters may be the method identifier of the quantization method and/or the indication bit having a mapping relationship with the quantization method.

The quantization parameters may also be the precision value of the quantization precision or the number of the quantization precision and any information used to determine the quantization precision.

The higher the quantization precision, the higher the similarity between the quantized CSI and the original CSI. The lower the quantization precision, the lower the similarity between the quantized CSI and the original CSI.

In some embodiments, different quantization methods supported by the UE may achieve different quantization precisions.

In some embodiments, the quantization methods include at least one of the following: scalar quantization; and/or codebook quantization.

Scalar quantization may not involve vectors and is used for quantizing data elements in a data set without direction. Scalar quantization of the data elements to be quantized in the CSI may include: quantizing the data elements in the CSI to be quantized according to floating-point numbers with a preset precision and the like.

Codebook quantization is a quantization method requiring the use of a codebook to quantize the data elements in the data set.

The codebook can be predefined by a protocol or pre-interacted between the UE and the first network device.

For example, the codebook may be a matrix including multiple codewords.

In some embodiments, the codebook may include: codebook type 1, codebook type 2 and/or enhanced codebook 2. Codebook type 1, codebook type 2 and/or enhanced codebook 2 can be referred to in related art, and will not be elaborated here.

In some embodiments, the second information includes at least one of the following: quantization order of scalar quantization; codebook type of codebook quantization, with different types of quantization codebooks corresponding to different quantization precisions; and/or quantization factor of codebook quantization, with different types of quantization factors and/or different numbers of quantization factors corresponding to different quantization precisions.

For example, when scalar quantization is performed, the data elements in the CSI to be quantized are quantized as floating-point numbers. If the UE supports 16-bit floating-point numbers, 32-bit floating-point numbers or 8-bit floating-point numbers, the quantization orders are different. The higher the quantization order, the smaller the difference between the quantized data element and the data element to be quantized, and the higher the precision.

For example, if the number of codewords included in the codebook and/or the number of elements included in a single codeword are different, the quantization precision is different. For example, the number of codewords included in the codebook and/or the number of data elements included in a single codeword are both positively correlated with the quantization precision.

For example, it is assumed that a codebook includes: A1, A2, A3 and A4, a total of 4 columns, in other words, 4 columns of codewords; or B1, B2 and B3, a total of 3 rows, in other words, 3 rows of codewords. If the CSI to be quantized is also a 4*3 matrix, then according to the matrix to be quantized, the quantized result can be: ½*A1, 2*A2, 0*A3 and 3/2*A4. When transmitting the quantized CSI to be quantized, only the quantization coefficient and the identifier of codeword, that is, ½ and the codeword identifier A1, 2 and the codeword identifier A2, 0 and the codeword identifier A3, and 3/2 and the codeword identifier A4, are to be sent. This is merely an example of codebook quantization described here.

The quantization factor is the factor used in the process of codebook quantization. For example, if n quantization factors and at least one codebook are used to indicate a data row, then the larger n is, the smaller the difference between the data row before and after quantization, and thus the higher the corresponding quantization precision, where n can be any positive integer.

For example, Y=AX+B; Y can be the data before quantization in the CSI to be quantized; X is a codeword in the codebook; A and B are quantization factors used in the quantization process. A is the weighting factor in the quantization process and B is the addition or subtraction factor used in the quantization process. Therefore, the weighting factor and the addition or subtraction factor are different types of factors.

In some embodiments, the quantization factors may also include exponential factors or division factors or the like. It should be noted that, an illustrative example of quantization factors is be shown here merely, and the specific implementation is not limited to this example.

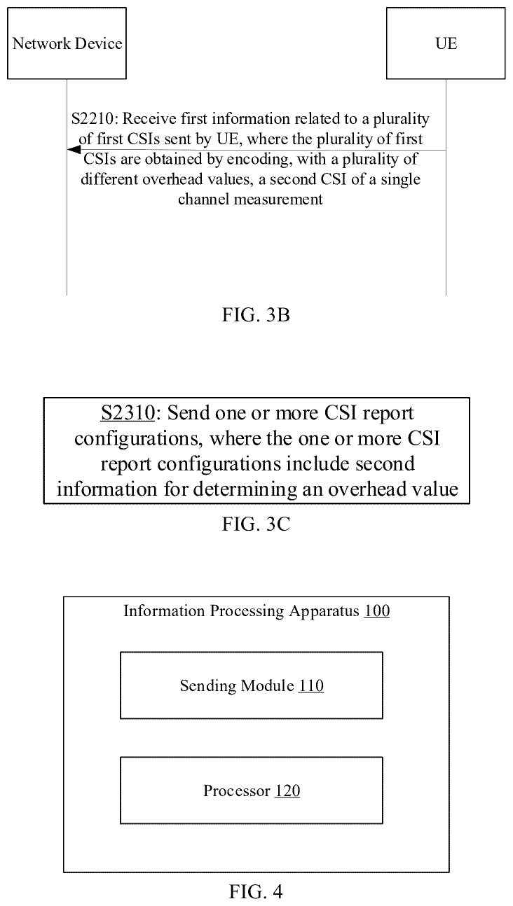

As shown in FIG. 3A, an information processing method in an embodiment of the present disclosure is executed by a network device, and includes the following.

In S2110, first information related to a plurality of first CSIs is received, where the plurality of first CSIs are obtained by encoding, with a plurality of different overhead values, a second CSI of a single channel measurement.

The network device may be the access device and/or core network device as shown in FIG. 1.

In the embodiments of the present disclosure, the CSI can be from the UE and other transmitting ends. For example, the CSI can be directly received from the UE or from the relay device.

It should be noted that, for a single channel measurement of the UE, multiple first CSIs may be sent. When the network device acts as the receiving end, the network device may receive multiple CSIs with different overhead values based on a single channel measurement of the UE. Each CSI carries the measurement result of the channel measurement with different parameters. The measurement result may include one or more measurement values. Different CSIs may correspond to different overhead values.

As shown in FIG. 3B, in an embodiment of the present disclosure, an information processing method is provided, being performed by a network device. The method includes the following.

In S2210, first information related to a plurality of first channel state information CSIs sent by UE is received, where the plurality of first CSIs are obtained by encoding, with a plurality of different overhead values, a second CSI of a single channel measurement.

In some embodiments, the method may further include: selecting the measurement result in one CSI from the multiple CSIs, with different overhead values, for use according to the requirements of the network device.

For example, the measurement result with the required accuracy and/or overhead value is selected from the multiple CSIs, with different overhead values, for use. Exemplarily, the measurement result can be used for training, optimizing and/or supervising the AI model.

Exemplarily, the embodiment shown in FIG. 3B can be implemented independently or in combination with any of the previous embodiments, for example, in combination with the embodiment shown in FIG. 3A.

As shown in FIG. 3C, an information processing method in an embodiment of the present disclosure is executed by a network device, and the method includes the following.

In S2310, one or more CSI report configurations are sent, where each of the one or more CSI report configurations includes second information for determining an overhead value.

In some embodiments of the present disclosure, the CSI report configuration may be configuration information sent by the network device to the UE for sending CSI. The configuration information may be carried in RRC signaling and/or MAC CE.

If the network device sends a CSI report configuration to the UE, the network device may receive, based on the CSI report configuration, multiple first CSIs obtained from one measurement.

For example, one or more CSI report configurations are sent to the UE. Any one of the CSI report configurations includes second information for determining an overhead value.

For example, the embodiment shown in FIG. 3C may be implemented independently or in combination with any of the previous embodiments, such as in combination with the embodiments shown in FIG. 3A to FIG. 3B.

In some embodiments, one CSI report configuration corresponds to multiple overhead values.

For example, the CSI report configuration may indicate multiple overhead values through the second information; or, the ID of the CSI report configuration is pre-mapped to multiple overhead values.

For example, in response to the UE receiving one CSI report configuration, the CSI report configuration corresponds to multiple overhead values.

In some embodiments, one CSI report configuration corresponds to one CSI resource configuration.

In some embodiments of the present disclosure, one CSI report configuration corresponds to one CSI resource configuration. The CSI resource configuration may be used at least to determine the CSI-RS to be measured. For example, the CSI resource configuration may include at least one of the following: a first ID, identifying the CSI resource used for receiving or measuring CSI-RS; and/or a second ID, identifying the CSI report configuration corresponding to the CSI resource configuration.

One CSI report configuration corresponding to multiple overhead values may correspond to one CSI resource configuration, so that the resources indicated by the CSI resource configuration can be used for sending CSIs with multiple different overhead values.

If one CSI report configuration corresponds to one overhead value, it can also be that one CSI report configuration corresponds to one CSI resource configuration.

Optionally, in the case of some embodiments, the type of the CSI report configuration may be periodic, aperiodic or semi-static. In other words, the type of the CSI report configuration defined for multiple overhead values may be periodic, aperiodic or semi-static.

In some embodiments, a CSI report configuration corresponds to an overhead value. In other words, in these embodiments, a CSI report configuration can be used to determine an overhead value. Thus, if first information related to multiple first CSIs is to be sent, multiple CSI report configurations may be required.

For example, in response to the UE receiving multiple CSI report configurations, each CSI report configuration among the multiple CSI report configurations corresponds to an overhead value.

In some embodiments, multiple CSI report configurations correspond to the same CSI resource configuration, where the overhead values corresponding to different CSI report configurations are different.

If a CSI report configuration corresponds to an overhead value, then multiple CSI report configurations may correspond to the same CSI resource configuration, and the overhead values corresponding to the same CSI resource configuration are different.

For example, a CSI resource configuration can be used at least for determining the transmission resource for sending the first information related to the first CSIs with multiple different overhead values.

In an embodiment, the type of the CSI report configuration is non-periodic or semi-static. Understandably, at least for the type of the CSI report configuration, corresponding to one overhead value, it may be non-periodic or semi-static.

A periodic CSI report configuration can indicate that the UE sends the CSI report periodically.

For example, at least one CSI report configuration is sent in the manner of broadcast, multicast or unicast.

The CSI report configuration may include configuration information related to CSI transmission. The configuration information can be RRC configuration information and/or MAC CE configuration information.

For example, the CSI report configuration may indicate at least one of the following: configuration identification (ID); report threshold, for example, when the measurement result reaches the report threshold, the CSI is determined; and/or resource information, indicating the reporting resource used for CSI transmission.

In some embodiments, the type of the CSI report configuration may be semi-static configuration, and the semi-static configuration has a semi-static period. Whether to send the CSI report on the corresponding semi-static period can be determined according to the state of the CSI report configuration. For example, if the network signaling indicates that the CSI report configuration corresponding to the semi-static period is set to the active state, the CSI report is sent on the semi-static period. If no network signaling indicates that the CSI report configuration corresponding to the semi-static period is set to the active state, or the network signaling indicates that the CSI report configuration corresponding to the semi-static period is set to the inactive state, the CSI report is not sent within the corresponding semi-static period. If the semi-static active state is not entered, then for a single channel measurement result, the CSI report with multiple overhead values will not be sent. If the CSI report with multiple overhead values is not sent for a single channel measurement result, then a single CSI report can be sent for a single channel measurement result, or no CSI report is sent.

In this way, the network device can trigger the UE to send or stop sending multiple CSI reports with different overhead values for a single channel measurement by sending an instruction indicating whether the UE enters the semi-static active state.

For example, the CSI report includes three types: non-periodic CSI report, semi-static CSI report and/or periodic CSI report. The specific type of the CSI report can be determined by the CSI report configuration. In other words, the CSI report configuration includes the type information. The type information indicates the type of the CSI report.

In some embodiments, the second information includes the following: at least one piece of first indication information, where one piece of the first indication information is used to determine, based on a predefined rule or a network configuration, an overhead value corresponding to the CSI report configuration; one piece of second indication information, used to determine the number of overhead values; and/or at least one piece of third indication information, used to determine at least one overhead value corresponding to the CSI report configuration separately.

In some embodiments, if one CSI report configuration corresponds to multiple overhead values of the CSI, the CSI report configuration may include multiple pieces of first indication information, with each piece of first indication information corresponding to one overhead value.

For example, at least one piece of first indication information may include one piece of first indication information or multiple pieces of first indication information. If a CSI report configuration corresponds to one CSI overhead, then the CSI report configuration includes one piece of first indication information. If a CSI report configuration corresponds to multiple CSI overhead values, then the CSI report configuration includes multiple pieces of first indication information.

For example, multiple pieces of first indication information may correspond to a bit bitmap or an indication field.

In a bit bitmap, one bit corresponds to one overhead value. If the value of the bit is a specific value, it indicates that the CSI report configuration corresponds to the overhead value mapped by the bit; otherwise, the CSI report configuration does not correspond to the overhead value. The specific value is 0 or 1. Accordingly, the number of overhead values corresponding to the CSI report configuration may be equal to the number of bits in the bit bitmap with the specific value.

An indication field corresponds to one overhead value. If the indication field can correspond to an overhead value or explicitly indicate the overhead value, it indicates that the CSI report configuration indicates the corresponding overhead value; otherwise, the CSI of the CSI report configuration does not correspond to the overhead value. If a CSI report configuration corresponds to a certain overhead value, the CSI report configuration contains the indication field, then the number of overhead values corresponding to the CSI report configuration may be equal to the number of indication fields. Whether a CSI report configuration corresponds to a certain overhead value does not depend on whether the CSI report configuration contains the indication field, but is to be determined based on the content of the indication field, then the number of overhead values corresponding to a CSI report configuration can be determined by the content of the indication field.

For example, one piece of first indication information corresponds to an overhead value of CSI. For instance, the first indication information indicates a preset parameter. The preset parameter has a corresponding relationship with the overhead value, or one piece of first indication information indicates an overhead value index. For example, the preset parameter may include: one or more of compression rate and/or input dimension and/or output dimension parameters and the like. After receiving the CSI report configuration, the overhead value can be determined based on one piece of first indication information according to the protocol agreement or the pre-configuration of the network.

The second indication information may be used to indicate the number of overhead values corresponding to a CSI report configuration. For example, if the second indication information indicates N, then a CSI report configuration corresponds to N overhead values of a single channel measurement. The value of N can be positive integers, such as 1 or 2 or the like.

For example, if a CSI report configuration corresponds to one overhead value, the value of the second indication information may be 1. If a CSI report configuration corresponds to x overhead values, the second indication information indicates x, where x may be a positive integer greater than or equal to 2.

In some embodiments, the UE may send first information related to multiple first CSIs of a single channel measurement based on multiple CSI report configurations, and the overhead values of the multiple first CSIs are different. For example, any one of the multiple CSI report configurations may correspond to the overhead value of one first CSI; or, some of the multiple CSI report configurations correspond to the overhead value of one first CSI, but some CSI report configurations may correspond to the overhead values of multiple first CSIs.

The aforementioned other information assisting in determining the overhead value based on the first indication information may be network configuration and/or predefined rules.

The network configuration may include: any network signaling sent by the network device before and after sending the CSI report. The network signaling may be RRC signaling and/or MAC layer signaling. The network signaling may include: the overhead value corresponding to the first indication information.

Optionally, one or more network signals sent by the network device before sending the CSI report configuration carry the overhead value corresponding to the first indication information.

Optionally, the network signaling may include: an indicator of the overhead value and the specific overhead value. The first indication information and the second indication information in the CSI report configuration may indicate the indicator of the overhead value or one or more parameters corresponding to the overhead value. The specific values of each overhead value can be determined by querying the network signaling based on the indicator or parameter. The indicator may include but is not limited to an identifier. The parameter includes but is not limited to a precoding matrix indicator or a rank indicator.

Accordingly, after receiving the first indication information, the UE queries the network configuration based on the first indication information to determine the overhead value corresponding to the first indication information.

Optionally, the predefined rules may include, but are not limited to, at least one of the following: rules agreed upon by the protocol; rules agreed upon through negotiation between the UE and the network device; rules designated by the communication operator; and/or rules designated by the device supplier and the like.

These are merely examples of predefined rules, and the specific implementation is not limited to the described examples.

All the described predefined manners include the overhead value corresponding to the first indication information. After receiving the first indication information, the UE can obtain the overhead value corresponding to the first indication information by querying the predefined rules.

In summary, after receiving the first indication information or the second indication information, the UE is to determine the number of overhead values corresponding to the CSI report configuration based on the first indication information or the second indication information, and then determine the specific values of each overhead value according to the predefined rules or network configuration.

In some other embodiments, the multiple overhead values corresponding to the CSI report configuration are configured by the network. The network configuration may refer to being pre-configured by the network device. For example, it may be configured through one or more network signaling sent by the network device before sending the CSI report configuration. The network signaling may include: RRC signaling and/or MAC CE and the like. For example, the network signaling may include: an indicator of the overhead value and the specific overhead value. The first indication information and the second indication information in the CSI report configuration may indicate the indicator of the overhead value. By querying the network signaling based on the indicator, the specific values of each overhead value can be determined. The indicator may include, but is not limited to, an identifier or a corresponding bit value.

In some embodiments, the third indication information indicates the overhead value corresponding to the CSI report configuration.

Alternatively, the third indication information includes a preset parameter for calculating at least one overhead value corresponding to the CSI report configuration.

The third indication information indicates the overhead value corresponding to the CSI report configuration. In other words, the third indication information directly indicates the overhead value, i.e., explicitly indicates the overhead value; or, the third indication information indicates a preset parameter that can be used to calculate the overhead value, i.e., the third indication information implicitly indicates the overhead value. When the CSI report configuration includes the third indication information, the number of overhead values indicated by the third indication information can be used to determine transmission of the first information related to the corresponding number of first CSIs according to the CSI report configuration for a single channel measurement.

In other words, in some embodiments, the third indication information explicitly indicates the overhead value of the CSI.

For example, the third indication information includes a preset parameter for calculating the overhead value corresponding to one CSI report configuration.

The preset parameter may be any encoding parameter for encoding the second CSI and/or a monitoring parameter related to the monitoring of CSI-RS.

The encoding parameter may include a compression parameter and/or a quantization parameter.

The monitoring parameter may include: the number of sub-bands for monitoring CSI-RS and/or the number of ports for monitoring CSI-RS and the like.

In summary, if the third indication information contains the preset parameter, the overhead value corresponding to the CSI report configuration is implicitly indicated through the preset parameter. After receiving the third indication information, the UE can calculate the overhead value based on the third indication information. The signaling overhead of the CSI report configuration can be saved.

In some embodiments, the preset parameter includes at least one of the following: an input dimension parameter before CSI compression/encoding; a compression rate/encoding rate of CSI compression/encoding; an output dimension parameter after CSI compression/encoding; the number of CSI-RS ports; the number of sub-bands; and/or the quantization parameter.

The UE measures the CSI-RS to obtain the original CSI.

In some embodiments, after obtaining the second CSI through the measurement of CSI-RS, CSI compression is performed. After completing the CSI compression, quantization of the compressed CSI is performed, and the first CSI is obtained after quantization.

In another embodiment, after obtaining the second CSI through the measurement of CSI-RS, CSI compression is performed to obtain the first CSI.

The aforementioned compression and/or quantization both belong to the encoding of the second CSI.

In some cases, “compression” in the embodiments of the present disclosure is also referred to as “encoding”. Therefore, the output dimension parameter after CSI compression/encoding is also the output dimension parameter after CSI compression or the output dimension parameter after CSI encoding.

For example, based on one input dimension parameter before CSI compression/encoding, one output dimension parameter before CSI compression/encoding, and the compression rate/encoding rate of CSI compression/encoding, an overhead value can be calculated.

For another example, based on the number of CSI-RS ports, one output dimension parameter after CSI compression/encoding, one input dimension parameter before CSI compression/encoding, and the compression rate/encoding rate of CSI compression/encoding, an overhead value can be calculated.

For another example, after one or more parameters affecting the overhead value are uniquely determined, the overhead value can also be determined based on the remaining parameters affecting the overhead value.

For example, if the number of CSI-RS ports and/or the number of sub-bands are pre-configured through CSI resource configuration, the CSI report configuration can indicate, through the first indication information, the output dimension parameter after CSI compression/encoding, the input dimension parameter before CSI compression/encoding, and the compression rate, and the overhead value can be calculated.

When performing CSI compression/encoding, CSI compression/encoding parameters will be used.

The CSI compression/encoding parameters may include at least one of the following. The compression method can also be called the encoding method, or the compression/encoding method. Different compression methods can adopt different types of AI models for CSI compression. The AI model may include a fully connected AI model and/or a transformer model.

The compression rate can also be called the encoding rate, or the compression/encoding rate.

The higher the compression rate, the greater the data volume ratio of CSI before and after compression, and vice versa.

If an AI model is used for CSI compression, the input dimension and output dimension of the compression model used for CSI compression are determined. The input dimension of the compression model can be indicated by the CSI compression/encoding input dimension parameter. The output dimension of the compression model can be indicated by the CSI compression/encoding output dimension parameter.

In some embodiments, the input dimension of the compression model may be equal to the output dimension of the compression model, or the input dimension of the compression model may be greater than the output dimension of the compression model.

In some embodiments, the CSI compression/encoding input dimension parameter can also be referred to as the CSI compression input parameter or the CSI encoding input dimension parameter.

In some embodiments, the number of CSI-RS ports is the number of ports for UE receiving CSI-RS.

In some embodiments, the number of sub-bands is the number of sub-bands for UE receiving CSI-RS.

In some embodiments, the product of the number of CSI-RS ports, the number of sub-bands, and the compression rate may be equal to the output dimension of the compressed model. When performing CSI quantization, quantization parameters will be used.

The quantization parameter can indicate at least one of the following: quantization method; and/or quantization precision.

In an embodiment 1, the CSI report configuration (report config) includes multiple overhead values, and one CSI report configuration corresponds to one CSI resource configuration (resource config). The CSI report configuration corresponds to the CSI report. The CSI report may be a report message carrying the aforementioned first CSI.

In an embodiment 2, the non-periodic CSI trigger state or semi-static CSI activation state includes multiple CSI report configurations. Each CSI report configuration corresponds to one overhead value. The CSI resource configurations corresponding to multiple CSI report configurations IDs are the same.

In other words, when each CSI report configuration corresponds to multiple overhead values, the configurable type of the CSI report configuration (report Config Type) can be periodic, semi-static, or non-periodic.

Optionally, for embodiment 1 or 2, the report quantity field is an information element in the CSI report configuration. Examples of the report quantity field can be as follows.

Example 1 is cri-RI-PMI 1-PMI 2, where PMI1 corresponds to one overhead value/channel compression rate, and PMI2 corresponds to one overhead value/channel compression rate. The overhead values corresponding to PMI1 and PMI2 can be predefined or configured by the network.

Example 2 is cri-RI-PMI-x, for example, x=2, corresponding to the UE reporting two compressed CSIs with two overhead values/channel compression rates. The two values can be predefined rules or configured by the network.

For example, cri can be an abbreviation of CSI Resource index. The cri can be a channel state information resource index.

RI is Rank Indication.

PMI can be an abbreviation of Precoding Matrix Indicator, indicating a precoding matrix indicator.

The network can indicate the specific overhead value through a newly defined field. For example, the field can be a PMI-compression Indicator field or an AI precoding matrix configuration (AIPMI config).

In Example 3, the configuration of the overhead value can be determined by the number of reported bits as configured; or determined by the reported dimension and parameters as configured; or determined by the number of CSI-RS ports, subbands, and compression rate as configured. In an embodiment 3, one CSI report configuration includes multiple overhead values.

When the reporting period is reached or a triggering event is met, the UE sends the corresponding CSI report according to multiple overhead values. At the same time, the options included in the report quantity of the CSI report configuration should include the reporting of compressed CSI with multiple overhead values, such as CRI-RI-PMI1-PMI2.

In an embodiment 4, each CSI report configuration includes an overhead value. For the non-periodic reporting state (CSI-Aperiodic Trigger State), a non-periodic reporting state includes multiple first CSI report IDs (associatedReportConfigInfoList), where the CSI-RS configuration IDs corresponding to the CSI report IDs is to be the same, so as to ensure that the CSI compression results reported by the UE are all based on the same measurement result.

As shown in FIG. 4, an apparatus for processing information is provided in the present disclosure. The information processing apparatus 100 includes a sending module 110, and a processor 120.

The sending module 110 is configured to send first information related to a plurality of first CSIs, where the plurality of first CSIs are obtained by encoding, with a plurality of different overhead values, a second CSI of a single channel measurement.

The information processing apparatus 100 may include a UE. The UE may be a mobile terminal and/or a fixed terminal. The terminal may be, but is not limited to, a mobile phone, a wearable device, a vehicle-mounted terminal, a roadside unit (RSU), a smart home terminal, a smart office device, an industrial sensor device, and/or a medical device and the like. In some examples, the terminal may be a Redcap terminal or a new radio (NR) terminal of a predetermined version.

In some examples, the sending module 110 may correspond to a transceiver antenna and the like.

In some examples, the information processing apparatus 100 may further include: a storage module (not shown). The storage module is connected to the sending module 110 and processor 120 and can be at least used to temporarily store CSI reports, for example, after generating a CSI report and before sending the CSI report.

The information processing apparatus 100 also includes the following.

A receiving module (not shown) is configured to receive one or more CSI report configurations, where the one or more CSI report configurations include second information for determining the overhead value.

In response to receiving one CSI report configuration, the CSI report configuration corresponds to multiple overhead values.

It can be understood that a CSI report configuration corresponds to a CSI resource configuration.

It can be understood that the type of CSI report configuration is periodic, non-periodic, or semi-static.

It can be understood that in response to receiving the multiple CSI report configurations, each of the multiple CSI report configurations corresponds to one overhead value.

It can be understood that the multiple CSI report configurations correspond to one CSI resource configuration.

It can be understood that a type of the CSI report configuration is aperiodic or semi-static. It can be understood that the second information includes the following:
at least one piece of first indication information, where one piece of the first indication information is used for determining, based on a predefined rule or a network configuration, an overhead value corresponding to the CSI report; one piece of second indication information, used to determine the number of overhead value corresponding to one CSI report configuration; and/or at least one piece of third indication information, used to determine at least one overhead value of the CSI report configuration independently.

It can be understood that the multiple overhead values corresponding to at least one piece of first indication information are predefined.

Alternatively, the multiple overhead values corresponding to at least one piece of first indication information are configured by the network.

It can be understood that the third indication information indicates the overhead value corresponding to the CSI report configuration.

Alternatively, the third indication information includes a preset parameter used to calculate the overhead value corresponding to the CSI report configuration.

It can be understood that the preset parameter includes at least one of following: an input dimension parameter before CSI compression/encoding; a compression rate/encoding rate of the CSI compression/encoding; an output dimension parameter after the CSI compression/encoding; the number of CSI-RS port; the number of sub-band; and/or a quantization parameter.

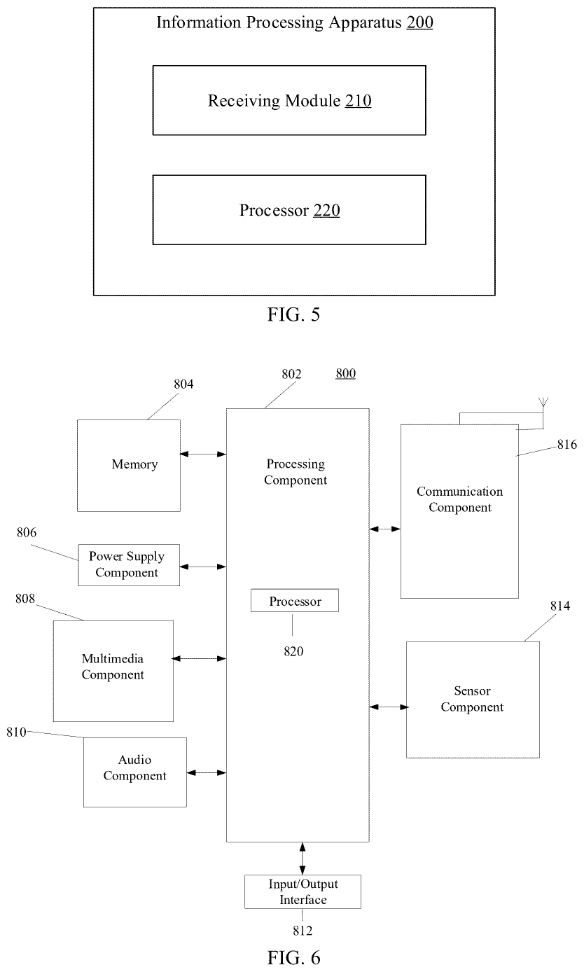

As shown in FIG. 5, embodiments of the present disclosure provide an apparatus for processing information 200, which includes a receiving module 210 and processor 220.

The receiving module 210 is configured to receive first information related to a plurality of first CSIs, where the plurality of first CSIs are obtained by encoding, with a plurality of different overhead values, a second CSI of a single channel measurement.

The information processing apparatus 200 may be included in a network device. The network device may be an access device.

In some embodiments, the information processing apparatus may further include: a storage module (not shown). The storage module is connected to the receiving module 210 and processor 220 and is at least capable of storing CSI reports.

The receiving module 210 may correspond to a transceiver antenna of the network device or an air interface, and is used for data interaction with a sending end such as UE.

In some embodiments, the information processing apparatus may further include the following.

A sending module (not shown) is configured to send one or more CSI report configurations, with each of the one or more CSI report configurations including second information for determining an overhead value.

In some embodiments, in response to sending one CSI report configuration, the CSI report configuration corresponds to multiple overhead values.

In some embodiments, one CSI report configuration corresponds to one CSI resource configuration.

In some embodiments, the type of the CSI report configuration is periodic, aperiodic or semi-static.

In some embodiments, in response to sending multiple CSI report configurations, each of the multiple CSI report configurations corresponds to one overhead value.

In some embodiments, the multiple CSI report configurations correspond to one CSI resource configuration.

In some embodiments, the type of the CSI report configuration is aperiodic or semi-static.

In some embodiments, the second information includes: at least one piece of first indication information, where one piece of the first indication information is used for determining, based on a predefined rule or a network signaling, at least one overhead value corresponding to the CSI report configuration; one piece of second indication information, used to determine the number of overhead values corresponding to a CSI report configuration; and/or, at least one piece of third indication information, used to determine at least one overhead value corresponding to a CSI report configuration independently.

In some embodiments, the multiple overhead values corresponding to at least one piece of first indication information are predefined.

Alternatively, the multiple overhead values corresponding to at least one piece of first indication information are configured by the network.

In some embodiments, the third indication information indicates an overhead value corresponding to a CSI report configuration.

Alternatively, the third indication information includes a preset parameter for calculating an overhead value corresponding to a CSI report configuration.

It can be understood that the preset parameter includes at least one of the following: CSI compression/encoding compression rate/encoding rate; output dimension parameter after CSI compression/encoding; the number of CSI-RS ports; the number of sub-bands; and/or quantization parameter.

Embodiments of the present disclosure provide a communication device, including: a memory for storing instructions executable by a processor; and a processor, connected to the memory. Where the processor is configured to implement the information processing method according to any of the described embodiments and/or technical solutions.

The processor may include various types of storage medium. The storage medium are non-transitory computer storage medium and can continue to remember and store the information thereon even after the communication device is powered off.

The communication device includes: a UE or a network device.

The processor may be connected to the memory through a bus, and the like, for reading the executable program stored on the memory to implement, for example, at least one of the methods shown in FIG. 2A to FIG. 2E or FIG. 3A to FIG. 3C.

FIG. 6 shows a block diagram of a UE 800 according to an exemplary embodiment. For example, the UE 800 can be a mobile phone, a computer, a digital broadcast user equipment, a message transceiver device, a game console, a tablet device, a medical device, a fitness device, a personal digital assistant and the like.

Referring to FIG. 6, the UE 800 may include one or more of the following components: a processing component 802, a memory 804, a power supply component 806, a multimedia component 808, an audio component 810, an input/output (I/O) interface 812, a sensor component 814, and a communication component 816.

The processing component 802 typically controls the overall operation of the UE 800, such as operations related to display, phone calls, data communication, camera operation, and recording operations. The processing component 802 may include one or more processors 820 to execute instructions to generate all or part of the steps of the described methods. Additionally, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support the operation of the UE 800. Examples of such data include instructions for any application or method operating on the UE 800, contact data, phonebook data, messages, pictures, videos, and the like. The memory 804 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, disk or optical disc.

The power supply component 806 provides power to various components of the UE 800. The power supply component 806 may include a power management system, one or more power supplies, and other components associated with generating, managing, and distributing power to the UE 800.

The multimedia component 808 includes a screen that provides an output interface between the UE 800 and the user. In some embodiments, the screen may include a liquid crystal display (LCD) and a touch panel (TP). If the screen includes a touch panel, the screen can be implemented as a touchscreen to receive input signals from the user. The touch panel includes one or more touch sensors to sense touch, swipe, and gestures on the touch panel. The touch sensors can not only sense the boundaries of touch or swipe actions but also detect the duration and pressure associated with the touch or swipe operation. In some embodiments, the multimedia component 808 includes a front camera and/or a rear camera. When the UE 800 is in an operating mode, such as a shooting mode or a video mode, the front camera and/or the rear camera can receive external multimedia data. Each front camera and rear camera can be a fixed optical lens system or have a focal length and optical zoom capability.

The audio component 810 is configured to output and/or input audio signals. For example, the audio component 810 includes a microphone (MIC), which is configured to receive external audio signals when the UE 800 is in an operating mode, such as a call mode, a recording mode, and a voice recognition mode. The received audio signals can be further stored in the memory 804 or sent via the communication component 816. In some embodiments, the audio component 810 also includes a speaker for outputting audio signals.

The I/O interface 812 provides an interface between the processing component 802 and peripheral interface modules, which can be a keyboard, click wheel, button, etc. These buttons may include, but are not limited to: home button, volume button, power button and lock button.

The sensor component 814 includes one or more sensors for providing various status evaluations for the UE 800. For example, the sensor component 814 can detect the turn-on/-off state of the device 800, the relative positioning of components, such as the display and keypad of the UE 800. The sensor component 814 can also detect the position change of the UE 800 or a component of the UE 800, the presence or absence of contact between the user and the UE 800, the orientation or acceleration/deceleration of the UE 800, and the temperature change of the UE 800. The sensor component 814 may include a proximity sensor configured to detect the presence of an object without any physical contact. The sensor component 814 may also include a light sensor, such as a CMOS or CCD image sensor, for use in imaging applications. In some embodiments, the sensor component 814 may also include an acceleration sensor, a gyroscope sensor, a magnetic sensor, a pressure sensor or a temperature sensor.

The communication component 816 is configured to facilitate wired or wireless communication between the UE 800 and other devices. The UE 800 can access a wireless network based on communication standards, such as WiFi, 2G or 3G, or a combination thereof. In an exemplary embodiment, the communication component 816 receives broadcast signals or broadcast-related information from an external broadcast management system via a broadcast channel. In an exemplary embodiment, the communication component 816 also includes a near field communication (NFC) module to facilitate short-range communication. For example, the NFC module may be based on radio frequency identification (RFID) technology, infrared data association (IrDA) technology, ultra-wideband (UWB) technology, Bluetooth (BT) technology, and other technologies.

In an exemplary embodiment, the UE 800 may be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components to perform the described methods.

In an exemplary embodiment, a non-transitory computer-readable storage medium including instructions is also provided, such as the memory 804 including instructions, which can be executed by the processor 820 of the UE 800 to generate the described methods. For example, the non-transitory computer-readable storage medium may be ROM, random access memory (RAM), CD-ROM, magnetic tape, floppy disk, optical data storage devices, or the like.

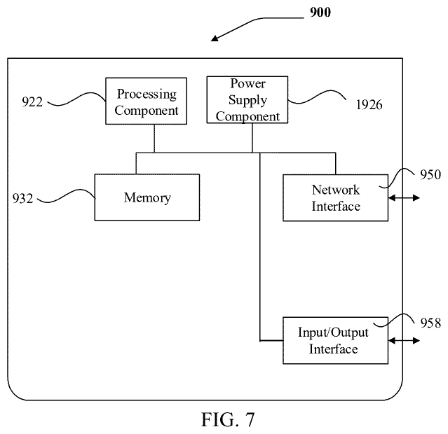

As shown in FIG. 7, an embodiment of the present disclosure shows a structure of a network device. Referring to FIG. 7, the network device 900 includes a processing component 922, which further includes one or more processors (not shown), and memory resources represented by the memory 932 for storing instructions executable by the processing component 922, such as applications. The applications stored in the memory 932 may include one or more modules, each corresponding to a set of instructions. In addition, the processing component 922 is configured to execute instructions to perform the described methods applied on the network device, for example, at least one of the methods shown in FIG. 2A to FIG. 2E or FIG. 3A to FIG. 3C.

The network device 900 may also include a power supply component 1926 configured to perform power management of the network device 900, a wired or wireless network interface 950 configured to connect the network device 900 to a network, and an input/output (I/O) interface 958. The network device 900 may operate based on an operating system stored in the memory 932, such as Windows Server™, Mac OS X™, Unix™, Linux™, FreeBSD™, or similar.

A person skilled in the art will readily appreciate other embodiments of the present disclosure upon consideration of the specification and practice of the disclosed invention. The present disclosure is intended to cover any variations, uses or adaptations of the disclosed embodiments that follow the general principles of the disclosed embodiments and include common knowledge or conventional techniques in the technical field of the present disclosure that are not disclosed herein. The specification and embodiments are merely exemplary, and the true scope and spirit of the disclosed embodiments are indicated by the appended claims.

It should be understood that the disclosed embodiments are not limited to the precise structure described herein and shown in the drawings, and various modifications and changes can be made without departing from the scope of the disclosed embodiments. The scope of the disclosed embodiments is only limited by the appended claims.

1. A method for processing information, being performed by a user equipment (UE), comprising:
sending first information related to a plurality of first channel state information (CSIs), and wherein the plurality of first CSIs are obtained by encoding, with a plurality of different overhead values, a second CSI of a single channel measurement.

2. The method according to claim 1, further comprising:
receiving one or multiple CSI report configurations, wherein the one or multiple CSI report configurations comprise second information used for determining an overhead value.

3. The method according to claim 1, further comprising:
receiving one CSI report configuration, wherein the one CSI report configuration corresponds to multiple overhead values.

4. The method according to claim 3, wherein,
the one CSI report configuration corresponds to one CSI resource configuration.

5. The method according to claim 3, wherein
a type of the one CSI report configuration is periodic, aperiodic, or semi-static.

6. The method according to claim 1, further comprising:
receiving multiple CSI report configurations, wherein each of the multiple CSI report configurations corresponds to one overhead value.

7. The method according to claim 6, wherein
the multiple CSI report configurations correspond to one CSI resource configuration.

8. The method according to claim 6, wherein
a type of each of the multiple CSI report configurations is aperiodic or semi-static.

9. The method according to claim 2, wherein the second information comprises at least one of:
at least one piece of first indication information, wherein the at least one piece of first indication information is used for determining, based on a predefined rule or a network configuration, at least one overhead value corresponding to each of the one or multiple CSI report configurations; or
one piece of second indication information, used for determining a number of the overhead value corresponding to one CSI report configuration; or
at least one piece of third indication information, used for determining at least one overhead value of the one or multiple CSI report configurations independently.

10. The method according to claim 2, wherein
the second information comprises at least one piece of third indication information, and
the third indication information indicates the overhead value corresponding to the one or multiple CSI report configurations; or,
the third indication information comprises a preset parameter used for calculating the overhead value corresponding to each of the one or multiple CSI report configurations.

11. The method according to claim 10, wherein the preset parameter comprises at least one of:
an input dimension parameter before CSI compression/encoding,
a compression rate/encoding rate of the CSI compression/encoding,
an output dimension parameter after the CSI compression/encoding,
a number of channel state information-reference signal (CSI-RS) ports
a number of sub-bands, or
a quantization parameter.

12. A method for processing information, being performed by a network device, comprising:
receiving first information related to a plurality of first channel state information (CSIs), wherein the plurality of first CSIs are obtained by encoding, with a plurality of different overhead values, a second CSI of a single channel measurement.

13. The method according to claim 12, further comprising:
sending one or multiple CSI report configurations, wherein the one or multiple CSI report configurations comprise second information used for determining an overhead value; and
in response to one CSI report configuration being sent, the one CSI report configuration corresponds to multiple overhead values; or
in response to multiple CSI report configurations being sent, each of the multiple CSI report configurations corresponds to one overhead value, and
wherein the one or multiple CSI report configurations correspond to one CSI resource configuration, and a type of the one CSI report configuration is periodic, aperiodic, or semi-static.

14-19. (canceled)

20. The method according to claim 13, wherein the second information comprises at least one of:
at least one piece of first indication information, wherein one piece of the at least one first indication information is used for determining, based on a predefined rule or a network configuration, at least one overhead value corresponding to the one CSI report configuration; or
one piece of second indication information, used for determining a number of overhead values corresponding to the one CSI report configuration; or
at least one piece of third indication information, used for determining the overhead value of the CSI report configuration independently.

21. The method according to claim 13, wherein
the second information comprises at least one piece of third indication information, and
the third indication information indicates the overhead value corresponding to the one or more CSI report configurations, or
the third indication information comprises a preset parameter used for calculating the overhead value corresponding to the one or more CSI report configurations.

22. The method according to claim 21, wherein the preset parameter comprises at least one of:
a compression rate/encoding rate of CSI compression/encoding,
an output dimension parameter after the CSI compression/encoding,
a number of channel state information-reference signal (CSI-RS) ports,
a number of sub-bands, or
a quantization parameter.

23-24. (canceled)

25. A device user equipment (UE), comprising:
a processor;
a transceiver;
a memory; and
an executable program stored on the memory and capable of being run by the processor,
wherein the processor, when running the executable program, is configured to:
send first information related to a plurality of first channel state information (CSIs), wherein the plurality of first CSIs are obtained by encoding, with a plurality of different overhead values, a second CSI of a single channel measurement.

26. A non-transitory computer-readable storage medium storing an executable program, wherein the executable program, when executed by a processor, causes the processor to implement the method according to claim 1.

27. A network device, comprising:
a processor;
a transceiver;
a memory; and
an executable program stored on the memory and capable of being run by the processor, and
wherein the processor, when running the executable program, is configured to implement the method according to claim 12.

28. A non-transitory computer-readable storage medium storing an executable program, wherein the executable program, when executed by a processor, causes the processor to implement the method according to claim 12.
